(19) United States
(12) Patent Application Publication
(10) Pub. No.: US 2014/0169030 A1
(43) Pub. Date: Jun. 19, 2014

(54) LIGHT GUIDE PLATE

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/867,109

(22) Filed: Apr. 21, 2013

(30) Foreign Application Priority Data
Dec. 13, 2012 (TW) 101147097

(51) Int. Cl. F21V 8/00

(52) U.S. Cl. CPC G02B 6/0043
USPC 362/606

(57) ABSTRACT

A light guide plate includes a light incident surface, a light emitting surface, and a number of micro-structures. The micro-structures are arranged on the light emitting surface. The micro-structures are parallel to each other and extends along a direction perpendicular to the light incident surface. The distance between each adjacent micro-structures are the same. The micro-structures in a light mixed area being non-uniformly distributed.

### BACKGROUND

1. Technical Field

The present disclosure relates to light guide plates, and particularly to a light guide plate which provides different amount of light from different portions.

2. Description of Related Art

FIG. 2 is an isometric view of a typical light guide plate used in a backlight module. A number of parallel micro-structures are uniformly distributed on a light emitting surface of the light guide plate. Thus, the amount of light from different portions of the light emitting surface is the same. However, under some conditions, a light guide plate which provides different amount of light from different portions is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a light guide plate, in accordance with an exemplary embodiment.

FIG. 2 is an isometric view of a typical light guide plate.

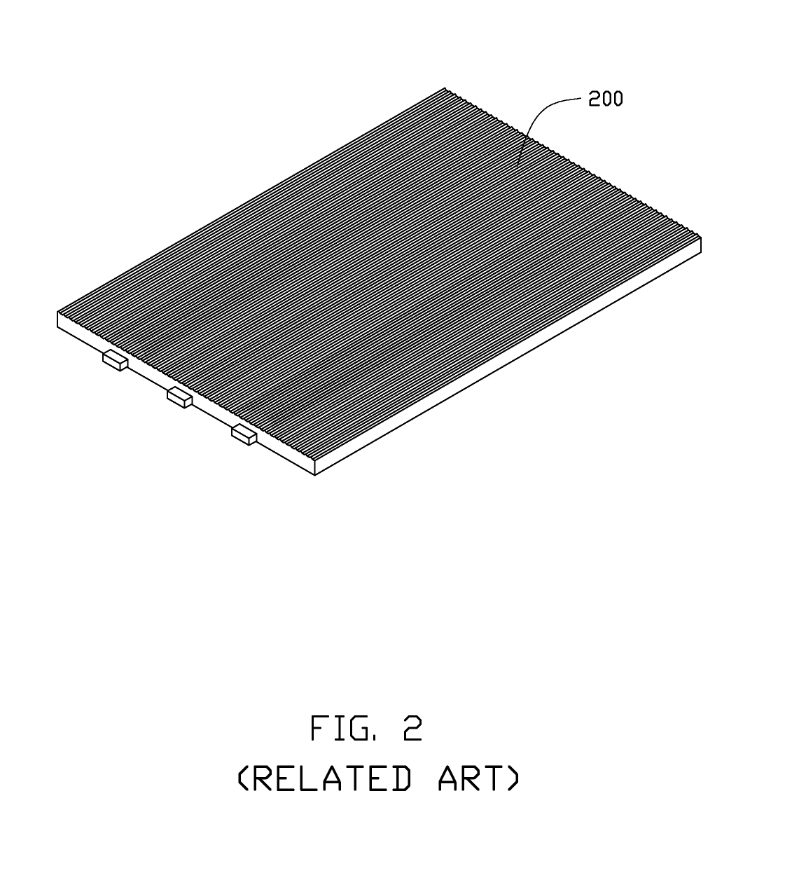

### DETAILED DESCRIPTION

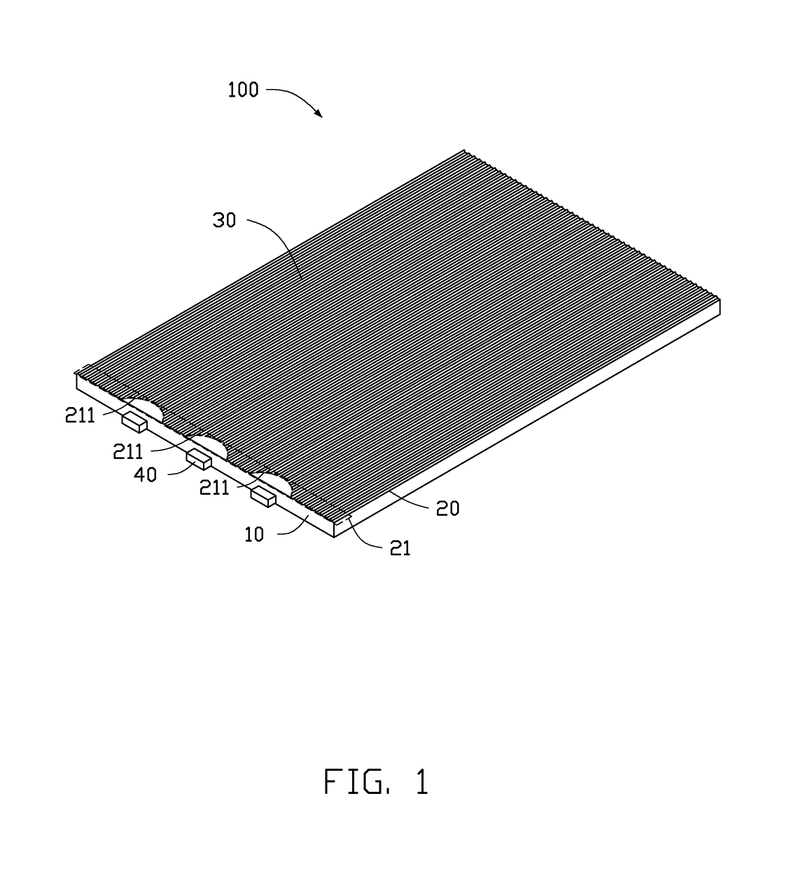

Referring to FIG. 1, an embodiment of a light guide plate 100 is illustrated. The light guide plate 100 includes a light incident surface 10, a light emitting surface 20, and a number of micro-structures 30 arranged on the light emitting surface 20. The light incident surface 10 is a sidewall of the light guide plate 100, and the light emitting surface 20 is a top surface of the light guide plate 100. A number of light sources 40 are arranged on the light incident surface 10. Each light source 40 is a light-emitting diode, and different light sources 40 emit different light. The light emitted from the light sources 40 enters the light guide plate 100 from the light incident surface 10. An area of the light emitting surface 20 adjacent to the light incident surface 10 is generally named as a light mixture area 21 (an area circled by dotted lines). The light from the light sources 40 are first mixed in the light mixture area after entering the light guide plate 100, and then the mixed light emits from the light emitting surface 20.

In this embodiment, the micro-structures 30 are parallel to each other and extends from a direction perpendicular to the light incident surface 10. The distance between each two adjacent micro-structures 30 is the same. In this embodiment, the micro-structures 30 in the light mixture area 21 are non-uniformly distributed. In this embodiment, ends of the micro-structures 30 adjacent to each light source 40 form an arc 211 (shown in a dotted line) in the light mixed area 21.

With such configuration, as the micro-structures 30 are non-uniformly distributed in the light mixture area, the amount of light from different portions of the light emitting surface 20 are different.

Although the present disclosure has been specifically described on the basis of the exemplary embodiment thereof, the disclosure is not to be construed as being limited thereto. Various changes or modifications may be made to the embodiment without departing from the scope and spirit of the disclosure.

1. A light guide plate comprising:
a light incident surface;
a light emitting surface adjacent to the light incident surface; and
a plurality of micro-structures arranged on the light emitting surface where light beams from light sources exit, the plurality of micro-structures being parallel to each other and extending along a direction perpendicular to the light incident surface, each micro-structure being an elongated rib protruding from the light emitting surface, the distance between each adjacent micro-structures being the same, the micro-structures in a light mixed area being non-uniformly distributed, the light mixed area being an area of the light emitting surface adjacent to the light incident surface.

2. The light guide plate as described in claim 1, wherein ends of the micro-structures adjacent to a light source on the light incident surface form an arch in the light mixture area.
